(19) United States
(12) Patent Application Publication
(10) Pub. No.: US 2023/0012900 A1
(43) Pub. Date: Jan. 19, 2023

(54) ELECTRIFIED DRIVE TRAIN HAVING A HEAT EXCHANGER ASSEMBLY IN A COOLING CIRCUIT, AND ELECTRIC VEHICLE HAVING A DRIVE TRAIN

(71) Applicant: Schaeffler Technologies AG & Co. KG, Herzogenaurach (DE)

(72) Inventors: Marco Grethel, Bühlertal (DE); Götz Rathke, Hohberg (DE)

(73) Assignee: Schaeffler Technologies AG & Co. KG, Herzogenaurach (DE)

(21) Appl. No.: 17/786,663

(22) PCT Filed: Dec. 3, 2020
(86) PCT No.: PCT/DE2020/101021

§ 371 Date: Jun. 17, 2022

(30) Foreign Application Priority Data
Dec. 18, 2019 (DE) 10 2019 134 942.7
Feb. 5, 2020 (DE) 10 2020 102 885.7

(51) Int. Cl. B60K 11/04; F16H 57/04

(52) U.S. Cl. CPC B60K 11/04; F16H 57/0476; F16H 57/0473; F16H 57/0415

(57) ABSTRACT

An electrified drive train for a motor vehicle has a heat generator, which includes at least one electric drive machine; and a cooling circuit, which is led through the electric drive machine and has a heat exchanger for removing heat from the cooling circuit. With respect to the direction of flow of the fluid used in the cooling circuit, the heat exchanger is arranged in the cooling circuit downstream of the heat generator to be cooled.

### CROSS-REFERENCE TO RELATED APPLICATIONS

This application is the U.S. National Phase of PCT Appln. No. PCT/DE2020/101021 filed Dec. 3, 2020, which claims priority to DE 10 2019 134 942.7 filed Dec. 18, 2019 and DE 10 2020 102 885.7 filed Feb. 5, 2020, the entire disclosures of which are incorporated by reference herein.

### TECHNICAL FIELD

The disclosure relates to an electrified drive train for a motor vehicle, having a heat generator, which comprises at least one electric drive machine and a cooling circuit, which is led through the electric drive machine and has a heat exchanger for removing heat from the cooling circuit. Furthermore, the disclosure relates to an electric vehicle having such an electrified drive train.

### BACKGROUND

Electrified drive trains that are powered purely electrically instead of by an internal combustion engine are already known from the prior art. However, the prior art always suffers from the disadvantage that, especially in such purely electrically driven vehicles, the combustion engine is missing as a heat source and electric auxiliary heaters have to be used in order to be able to implement, for example, a comfort function, such as heating of the passenger compartment.

### SUMMARY

It is therefore the object of the disclosure to avoid or at least to mitigate the disadvantages of the prior art. In particular, an electrified drive train and an electric vehicle are to be provided in which, if possible, no auxiliary heaters are required, but other heat sources are used.

This object is achieved with a generic device according to the disclosure in that the heat exchanger in the cooling circuit, in particular in the cooling oil circuit, is arranged downstream of the heat generator to be cooled in the direction of flow of the fluid, preferably oil, used in the cooling circuit.

This provides the advantage that the waste heat from the heat generators to be cooled can be utilized by making the heat dissipated to a heat removal circuit, usually a water circuit, available to the vehicle. By arranging the heat exchanger downstream of the heat generator to be cooled, a greater proportion of the heat can be utilized as waste heat compared to a case where the heat exchanger is arranged upstream of the heat generator to be cooled in order to maximize cooling capacity. This means that existing heat sources are used for the heating function.

Advantageous embodiments are claimed and are explained below.

According to a preferred embodiment, the heat exchanger can be arranged directly downstream of the heat generator to be cooled. This advantageously ensures that as much of the waste heat from the drive train as possible is made available to the vehicle. By arranging the heat exchanger directly downstream of the heat generator, heat losses due to convection can be prevented or at least minimized.

In addition, it is advantageous if the heat generator is the electric drive machine or a secondary unit, such as a power electronics unit and/or a clutch and/or a gearbox. The electric drive machine in particular makes a large amount of waste heat available. The power electronics unit is also a large heat generator.

Furthermore, it is expedient if the drive train comprises several heat generators to be cooled, wherein the heat exchanger is arranged downstream of the heat generator to be cooled having the greatest heat generation. This ensures that as much waste heat as possible is made available for comfort functions such as a heating function for the vehicle.

Optionally, in addition to the heat exchanger arranged downstream of the heat generator having the greatest heat generation, a further heat exchanger can be arranged in the cooling circuit for dividing the cooling capacity, wherein the further heat exchanger is arranged upstream of the heat generator having the greatest heat generation. Thus, the cooling capacity is divided upstream and downstream of the main heat source so that the main heat source is advantageously both cooled sufficiently and can dissipate sufficient waste heat to the passenger compartment.

Furthermore, according to an advantageous further development, the heat exchanger can be arranged, preferably directly, upstream of the heat generators to be cooled, apart from the heat generator having the greatest heat generation. This provides the advantage that the cooling capacity is optimally utilized.

It is also useful if a volume flow of the cooling circuit is divided into partial volume flows which run parallel to one another. This means that the volume flow of the cooling circuit is at least partially parallelized. Preferably, anode of the cooling circuit where the volume flow is divided into the partial volume flows is located, preferably directly, downstream of the heat exchanger.

According to a preferred further embodiment, the volume flow can have a first partial volume flow for cooling the gearbox. Alternatively or in addition, the volume flow can include a second partial volume flow for cooling the clutch.

Furthermore, it is expedient if the cooling circuit has a hydraulic resistance arranged in the volume flow for adjusting the flow rate of the partial volume flows. Thus, the flow rate of the partial volume flows can be adapted to the heat generator to be cooled and arranged in the respective partial volume flow. This allows the cooling fluid to be supplied as required.

Preferably, the hydraulic resistance can be designed as an active adjusting element, i.e., an adjusting element controlled by an electric actuator, such as an e-magnet or an e-motor, or as a passive adjusting element, i.e., an adjusting element (fixedly) set based on the existing hydraulic control variables.

According to an advantageous embodiment, the drive train can have the cooling circuit led through the electric drive machine and a second cooling circuit led through the power electronics unit, wherein the heat exchanger of the cooling circuit is arranged downstream of the electric drive machine and a heat exchanger of the second cooling circuit is arranged downstream of the power electronics unit.

The object of the disclosure is also achieved by an electric vehicle having an electrified drive train according to the disclosure.

According to a second aspect independent of the first aspect of the disclosure, the disclosure also relates to an electrified drive train for a motor vehicle, comprising at least one electric drive machine, and a heat removal circuit having at least a first heat exchanger and a second heat exchanger for removing heat from a cooling circuit led through the heat generator, wherein, in operation, a fluid, preferably water, used in the heat removal circuit, in particular in the cooling water circuit, flows through the first heat exchanger and, in parallel therewith, through the second heat exchanger. In other words, according to the disclosure, at least partial parallelization of the flow of the heat removal circuit is proposed. This provides the advantage that, in particular, the problems that arise when several heat exchangers have to be flooded with cooling fluid/cooling water, such as a summation of the flow resistances as well as a sequence of the heat exchangers, can be solved. For example, with two e-drives, two power electronics units and two e-motors need to be cooled, so four heat exchangers would have to be flooded. If these heat exchangers were arranged sequentially, the order in which the water is heated, the residual cooling capacity for the sequential heat exchanger, and the summation of the flow resistances would have to be considered. Usually, such a sequential arrangement results in too high a load pressure for the pump. Due to the partially parallel flow according to the disclosure, the load pressure for providing the cooling water flow can be kept low, so that the power required for the pump (Q*p) is also lower and the range of the electric vehicle is less negatively affected. Correspondingly, in accordance with the disclosure, an advantageous design is proposed with respect to the flow resistances of the fluid/water through the heat exchanger, an interaction with the flow rate and the achievable cooling capacity.

According to a preferred embodiment, a volume flow of the heat removal circuit at a node can be divided into a first partial volume flow led through the first heat exchanger and a second partial volume flow led through the second heat exchanger. Alternatively, it is also possible to divide the volume flow of the heat removal circuit several times, i.e., to distribute it to more than two partial volume flows.

In an advantageous embodiment, the heat removal circuit can have a hydraulic resistance by means of which the division of the volume flow between the first partial volume flow and the second partial volume flow can be adjusted. In other words, it is proposed to provide an adjustable hydraulic resistance in the direction of flow in the node or downstream of the node of parallelization. This can avoid an undesired division of the volume flow and thus the cooling capacity. Such an undesirable division results from the fact that individual heat exchangers have different flow resistances, for example due to tolerances.

According to the advantageous embodiment, the hydraulic resistance can be a passive adjusting element/a passive valve arrangement. This makes it possible to realize a necessary division of the volume flow once during commissioning of the line/water path. A passive adjusting element is understood to mean that the adjusting element performs an adjusting action, such as limiting the flow rate, based on the existing hydraulic regulating variables, such as a flow rate. Such a hydraulic regulating variable can also be tapped from the cooling circuit led through the heat generator and fed to the adjusting element via corresponding hydraulic effective surfaces.

According to the advantageous embodiment, the hydraulic resistance can be designed as an active adjusting element/an active valve arrangement. By providing an active adjusting element, the volume flow can be adjusted as desired. Preferably, the volume flow can be adjusted by the active adjusting element depending on an operating state of the (electric) vehicle and/or an operating state of the electric drive machine. Thus, the volume flow can be divided asymmetrically by the parallelization, for example temporarily. Cooling efficiency can be increased as required due this control system. An active adjusting element is understood to mean that the adjusting element can be controlled by an electric actuator, such as an electromagnet or an electric motor.

In addition, it is preferred if the (active or passive) adjusting element is designed as a poppet, sieve or rotary slide valve. This allows a relatively simple and inexpensive adjusting element to be installed.

In a preferred embodiment, the drive train can have two electric drive machines, each having a power electronics unit and an electric motor, wherein a heat exchanger for the two power electronics units, i.e., for the cooling circuit led through the power electronics units, is arranged upstream of the node in the common volume flow.

In another preferred embodiment, the drive train can comprise two electric drive machines, each having a power electronics unit and an electric motor, wherein a heat exchanger for one power electronics unit, i.e., for the cooling circuit led through one power electronics unit, is arranged downstream of the node in the first partial volume flow, and a heat exchanger for the other power electronics unit, i.e., for the cooling circuit led through the other power electronics unit, is arranged downstream of the node in the second partial volume flow.

According to the preferred embodiment, the heat exchangers for the power electronics units, i.e., for the cooling circuit/cooling circuits led through the power electronics units, can be arranged upstream of the heat exchangers for the electric motors, i.e., for the respective cooling circuits led through the electric motor, in the direction of flow of the fluid.

According to a third aspect of the disclosure, the first aspect of the disclosure and the second aspect of the disclosure can also be combined. Thus, the disclosure also relates to an electrified drive train for a motor vehicle having a cooling circuit/cooling oil circuit design according to the disclosure and a heat removal circuit/cooling water circuit design according to the disclosure.

In other words, the disclosure relates to a particular heat exchanger assembly in the water cooling circuit and/or in the oil cooling circuit in vehicles having electric motors. In particular, therefore, the disclosure relates to a drive train having at least one e-drive. Similar to a drive train having an internal combustion engine, any loss of drive machines should be effectively removed for component protection and put to good use, for example, to increase the efficiency of the vehicle. Accordingly, in particular in a drive train having several electric drive machines, the cooling water circuit/heat removal circuit and the cooling oil circuit/cooling circuit are improved according to the disclosure.

In previous cooling (oil) circuits, a heat exchanger would typically be arranged upstream of the object/heat generator to be cooled so that the cooling fluid, such as oil, would be as cool as possible and thus the cooling capacity would be as high as possible. However, since (purely) electrically driven vehicles in particular lack the important source of heat provided by the combustion engine, electric auxiliary heaters must be used, for example to increase comfort inside the passenger compartment and to heat it. According to the disclosure, the heat exchanger is arranged in the cooling circuit in such a manner that the waste heat from the drive function can be used at least partially as a heat source or for the heating function. Accordingly, the heat exchanger (or the heat exchangers) is/are arranged downstream of the object/heat generator to be cooled in order to transfer as much heat as possible into a heat removal circuit. This heat can then be used for the vehicle's heating functions. In other words, the heat exchanger/cooler is arranged (directly) downstream of the main heat generator in order to prevent convection and to be able to supply as much of the waste heat from the drive train to the vehicle as possible.

In other words, the heat removal circuit/cooling (water) circuit according to the disclosure is concerned with the flow resistances of the water through the heat exchanger and the interaction with the flow rate and thus the achievable cooling capacity. In order to keep the load pressure for providing the cooling water flow and thus the required power as low as possible, it is problematic to have multiple heat exchangers—in the case of two e-drives, four heat exchangers for two power electronics units and two e-motors—sequentially flooded with cooling water, because the sequence of the heat exchangers and the summation of the flow resistances must be considered. According to the disclosure, an at least partial parallelization of the flow is proposed. However, due to tolerances, different flow resistances may result, which can lead to an undesired division of the cooling capacity. Therefore, an adjustable hydraulic resistance is provided downstream of the node of the parallelization in the direction of flow, which can be active, i.e., continuously adjustable, or passive, meaning initially adjustable.

### BRIEF DESCRIPTION OF THE DRAWINGS

The disclosure is explained below with the aid of drawings. In the figures:

FIG. 1 shows a schematic representation of a part of a cooling circuit according to the disclosure in a first embodiment,

FIG. 2 shows a schematic representation of another part of the cooling circuit according to the disclosure,

FIG. 3 shows a schematic representation of a heat removal circuit according to the disclosure in a first embodiment,

FIG. 4 shows a schematic representation of a heat removal circuit according to the disclosure in a second embodiment

FIG. 5 shows a schematic representation of a heat removal circuit according to the disclosure in a third embodiment,

FIG. 6 shows a schematic representation of an exemplary heat removal circuit, and

FIG. 7 shows an example of the basic structure of a cooling system having a cooling circuit and a heat removal circuit.

### DETAILED DESCRIPTION

The figures are only schematic in nature and serve only for understanding the disclosure. The same elements are provided with the same reference symbols. The features of the individual embodiments can be interchanged.

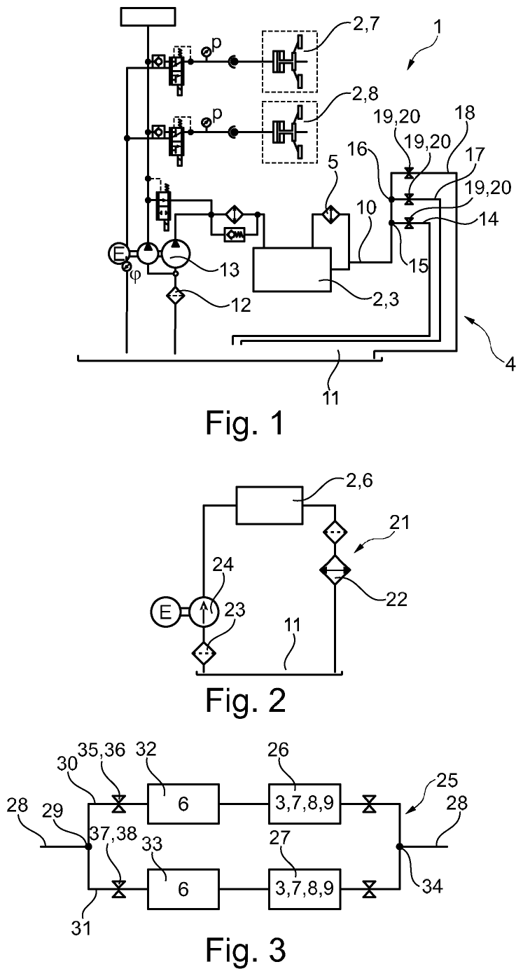

FIG. 1 schematically shows a first part of a drive train 1 according to the disclosure for a motor vehicle, in particular an electric vehicle. The drive train 1 is electrified. The drive train 1 has a heat generator 2. The heat generator 2 comprises at least one electric drive machine 3 having an electric motor 3. The drive train 1 has a cooling circuit 4 led through the electric drive machine 3. The cooling circuit 4 has a heat exchanger 5 for removing heat from the cooling circuit 4.

According to the disclosure, with respect to the direction of flow of the fluid used in the cooling circuit 4, in particular oil, the heat exchanger 5 is arranged in the cooling circuit 4 downstream of the heat generator 2 to be cooled. In the cooling circuit 4 shown in FIG. 1, the heat exchanger 5 is arranged downstream of the electric drive machine 3. As a result, a large portion of the heat generated by the electric drive machine 3 can be used as waste heat to heat a passenger compartment.

The drive train 1 also has one or more secondary units. A secondary unit can be, for example, a power electronics unit 6 (cf. FIG. 2). A secondary unit can be, for example, a first clutch 7 or a second clutch 8. A secondary unit can also, for example, be a gearbox 9. Accordingly, the drive train 1 usually has several heat generators 2 to be cooled. According to the disclosure, the heat exchanger 5 is arranged in particular downstream of the heat generator 2 to be cooled having the greatest heat generation, such as the drive machine 3. In addition, the heat exchanger 5 can be arranged upstream, in particular directly upstream, of the heat generators 2 to be cooled, apart from the heat generator 2 having the greatest heat generation, i.e., in this case the drive machine 3. This allows sufficient cooling capacity to be provided to the other heat generators 2.

In the embodiment shown, a volume flow 10 of the cooling circuit 4 is divided into partial volume flows that run parallel to one another. The oil is thus drawn from an oil sump 11, preferably via a suction filter 12, by a cooling pump 13. Then the oil of the volume flow 10 is conveyed by the cooling oil pump 13 through the drive machine 3. In the direction of flow behind it, the heat exchanger 5 is flooded. Downstream, the volume flow 10 is divided. A first partial volume flow 14 diverts from the volume flow 10 at a first node 15, which has a lower flow rate than the volume flow 10. Downstream, the volume flow is divided at a second node 16 into a second partial volume flow 17 and a third partial volume flow 18. The first partial volume flow 17 can, for example, be designed to cool the first clutch 7 and/or the second clutch 8. The first partial volume flow 17 can, for example, be designed to cool the gearbox 9. Preferably, the flow rate of the first partial volume flow 14 and the flow rate of the second partial volume flow 17 and the third partial volume flow 18 together are substantially equal.

A hydraulic resistance 19 is arranged in the volume flow 10 for adjusting the flow rate of the partial volume flows. In the embodiment shown, a hydraulic resistance 19 is arranged in each of the three partial volume flows 14, 17, 18. In the embodiment shown, the hydraulic resistance 19 is designed as a passive adjusting element 20. The hydraulic resistance 19 can also be designed as an active adjusting element, even though this is not shown in FIG. 1.

Thus, according to the disclosure, the drive train 1 has the cooling circuit 4 led through the electric drive machine 3, in which the heat exchanger 5 of the cooling circuit 4 is arranged downstream of the electric drive machine 3.

FIG. 2 shows another part of the drive train 2. FIG. 2 shows a second cooling circuit 21 led through the power electronics unit 6. A heat exchanger 22 of the second cooling circuit 21 is arranged downstream, preferably directly downstream, of the power electronics unit 6 in the direction of flow of the cooling fluid. This allows the waste heat from the power electronics unit to be utilized. In the second cooling circuit 21, the oil is drawn from the oil sump 11, preferably via a suction filter 23, by a cooling pump 24. Then the oil is conveyed through the power electronics unit 6 by the cooling oil pump 24. In the direction of flow behind it, the heat exchanger 22 is flooded.

FIGS. 3 to 6 show schematic representations of a heat removal circuit 25 of the drive train 1 according to the disclosure. In particular, the FIGS. 3 to 5 show the structure of the heat removal circuit 25 according to one aspect of the disclosure with respect to a heat exchanger assembly.

The drive train 1 has the heat generator 2, comprising the at least one electric drive machine 3. In order to be able to remove the heat from a cooling circuit led through the heat generator 2, the drive train 1 has the heat removal circuit 25. The heat removal circuit 25 has at least a first heat exchanger 26 and a second heat exchanger 27 for removing heat from the cooling circuit. The cooling circuit can be formed, for example, by the first cooling circuit 4 and the second cooling circuit 21 shown in FIGS. 1 and 2. However, the cooling circuit can also be formed in a different manner. An exemplary design of a cooling system having a cooling circuit and a heat removal circuit is explained with reference to FIG. 7.

According to the disclosure, the heat removal circuit 25 is designed such that, in operation, a fluid used in the heat removal circuit 25, such as water, flows through the first heat exchanger 26 and, in parallel, through the second heat exchanger 27. This means that a volume flow 28 of the heat removal circuit 25 is at least partially parallelized, i.e., divided into at least two partial volume flows. The volume flow 28 is divided at a node 29 into a first partial volume flow 30 and a second partial volume flow 31. At least one heat exchanger is arranged in each of the partial volume flows 30, 31 so that the heat exchangers are flowed through in parallel.

In the embodiments shown in FIGS. 3 to 5, the drive train 1 has two electric drive machines 3. In addition, the drive train 1 has the power electronics unit 6, the first clutch 7 and/or the second clutch 8 and the gearbox 9 for each drive machine 3.

In the embodiment shown in FIG. 3, the drive train 1 has two heat exchangers for cooling the components for each drive machine 3. One heat exchanger for cooling the power electronics units 6 and one heat exchanger for cooling the drive machine 3, the first clutch 7, the second clutch 8 and/or the gearbox 9 are provided for each drive machine 3. In the first partial volume flow 30, the first heat exchanger 26 is arranged for cooling the (first) drive machine 3 (having the first clutch 7, the second clutch 8 and/or the gearbox 9). In the second partial volume flow 31, the second heat exchanger 27 is arranged for cooling the (second) drive machine 3 (having the first clutch 7, the second clutch 8 and/or the gearbox 9). A third heat exchanger 32 is arranged in the first partial volume flow 30 for cooling the (first) power electronics unit 6. A fourth heat exchanger 33 is arranged in the second partial volume flow 31 for cooling the (second) power electronics unit 6. The first partial volume flow 30 and the second partial volume flow 31 combine at a second node 34 to form the common volume flow 28. A first hydraulic resistance 35 is arranged in the first partial volume flow 30. The first hydraulic resistance 35 is designed as a passive adjusting element 36. A second hydraulic resistance 37 is arranged in the second partial volume flow 31. The second hydraulic resistance 37 is designed as a passive adjusting element 38. By means of the passive adjusting elements 36, 38, the division of the volume flow 28 into the partial volume flows 30, 31 can be adjusted initially.

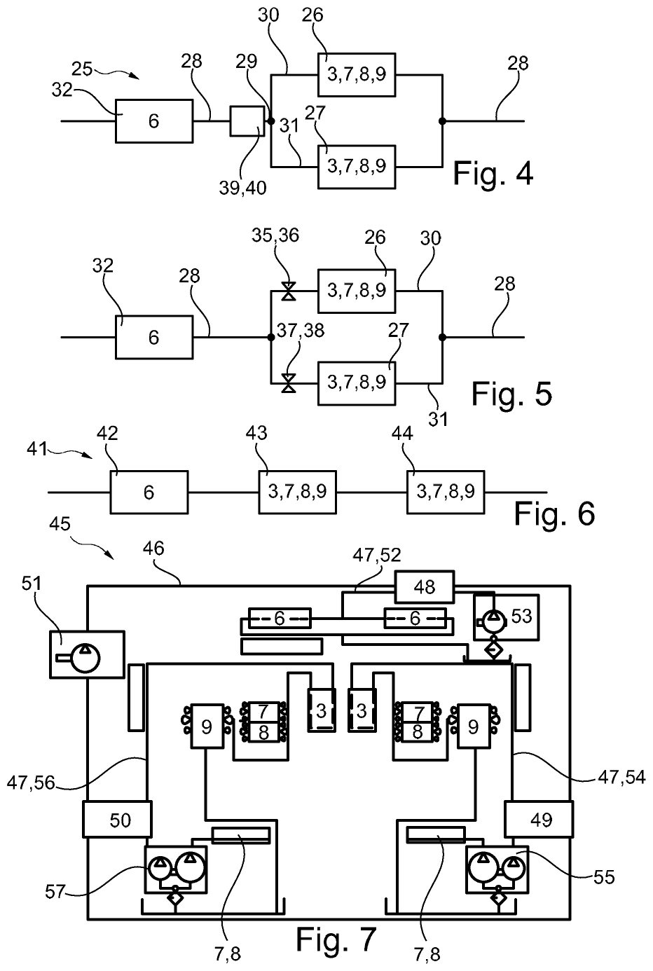

In the embodiment shown in FIG. 4, the drive train 1 has a heat exchanger for cooling the (first and second) power electronics units 6 and a heat exchanger each for cooling each of the two drive machines 3. In the first partial volume flow 30, the first heat exchanger 26 is arranged for cooling the (first) drive machine 3 (having the first clutch 7, the second clutch 8 and/or the gearbox 9). In the second partial volume flow 31, the second heat exchanger 27 is arranged for cooling the (second) drive machine 3 (having the first clutch 7, the second clutch 8 and/or the gearbox 9). Arranged in the volume flow 28 is the third heat exchanger 32 for cooling the (first and second) power electronics units 6. The first partial volume flow 30 and the second partial volume flow 31 combine at the second node 34 to form the common volume flow 28. A hydraulic resistance 39 is arranged at the node 29. The hydraulic resistance 39 is designed as an active adjusting element 40. By means of the active adjusting element 40, the division of the volume flow 28 into the partial volume flows 30, 31 can be continuously controlled.

In the embodiment shown in FIG. 5, the drive train 1 has a heat exchanger for cooling the (first and second) power electronics units 6 and a heat exchanger each for cooling each of the two drive machines 3. The first heat exchanger 26 is arranged in the first partial volume flow 30 for cooling the (first) drive machine 3. The second heat exchanger 27 is arranged in the second partial volume flow 31 for cooling the (second) drive machine 3. Arranged in the volume flow 28 is the third heat exchanger 32 for cooling the (first and second) power electronics units 6. The first hydraulic resistance 35 designed as the passive adjusting element 36 is arranged in the first partial volume flow 30. The second hydraulic resistance 37 designed as the passive adjusting element 38 is arranged in the second partial volume flow 31. By means of the passive adjusting elements 36, 38, the division of the volume flow 28 into the partial volume flows 30, 31 can be adjusted initially.

The embodiment shown in FIG. 6 shows a heat removal circuit 41 in which a heat exchanger 42 for the (first and second) power electronics 6, a heat exchanger 43 for cooling the (first) drive machine 3 (having the first clutch 7, the second clutch 8 and/or the gearbox 9) and a heat exchanger 44 for cooling the (second) drive machine 3 (having the first clutch 7, the second clutch 8 and/or the gearbox 9) are arranged sequentially one behind the other.

FIG. 7 shows an example of a basic structure of a cooling system 45. The cooling system 45 has a heat removal circuit/water cooling circuit 46 and multiple cooling circuits/cooling oil circuits 47. The structure of the heat removal circuit 46 corresponds to that of the heat removal circuit 41 shown in FIG. 6, in which a first heat exchanger 48, a second heat exchanger 49 and a third heat exchanger 50 are arranged in series one behind the other. A cooling pump 51 pumps the fluid, in this case water, through the heat removal circuit 46.

The first heat exchanger 48 exchanges heat with a first cooling circuit 52. In the first cooling circuit 52, fluid, in this case oil, is conveyed by a cooling pump 53 to the first power electronics 6 and to the second power electronics 6. The second heat exchanger 49 exchanges heat with a second cooling circuit 54. In the second cooling circuit 54, fluid, in this case oil, is conveyed by a cooling pump 55 to the first drive machine 3, the first clutch 7 and the second clutch 8 of a double clutch and the gearbox 9. The third heat exchanger 50 exchanges heat with a third cooling circuit 56. In the third cooling circuit 56, fluid, in this case oil, is conveyed by a cooling pump 57 to the second drive machine 3, the first clutch 7 and the second clutch 8 of a double clutch and the gearbox 9.

### LIST OF REFERENCE SYMBOLS

1 Drive train
2 Heat generator
3 Drive machine
4 Cooling circuit
5 Heat exchanger
6 Power electronics
7 First clutch
8 Second clutch
9 Gearbox
10 Volume flow
11 Oil sump
12 Suction filter
13 Cooling oil pump
14 First partial volume flow
15 First node
16 Second node
17 Second partial volume flow
18 Third partial volume flow
19 Hydraulic resistance
20 Passive adjusting element
21 Second cooling circuit
22 Heat exchanger
23 Suction filter
24 Cooling oil pump
25 Heat removal circuit
26 First heat exchanger
27 Second heat exchanger
28 Volume flow
29 Node
30 First partial volume flow
31 Second partial volume flow
32 Third heat exchanger
33 Fourth heat exchanger
34 Second node
35 Hydraulic resistance
36 Passive adjusting element
37 Hydraulic resistance
38 Passive adjusting element
39 Hydraulic resistance
40 Active adjusting element
41 Heat removal circuit
42 First heat exchanger
43 Second heat exchanger
44 Third heat exchanger
45 Cooling system
46 Heat removal circuit
47 Cooling circuit
48 First heat exchanger
49 Second heat exchanger
50 Third heat exchanger
51 Cooling pump
52 First cooling circuit
53 Cooling pump
54 Second cooling circuit
55 Cooling pump
56 Third cooling circuit
57 Cooling pump

1. An electrified drive train for a motor vehicle, comprising: a heat generator, which comprises at least one electric drive machine, and a cooling circuit, which is led through the electric drive machine and has a heat exchanger for removing heat from the cooling circuit, wherein, with respect to a direction of flow of fluid used in the cooling circuit, the heat exchanger is arranged in the cooling circuit downstream of the heat generator to be cooled.

2. The electrified drive train according to claim 1, wherein the heat exchanger is arranged directly downstream of the heat generator to be cooled.

3. The electrified drive train according to claim 1, wherein the heat generator is the electric drive machine or a secondary unit, such as a power electronics and/or a clutch and/or a gearbox.

4. The electrified drive train according to claim 1, wherein the drive train has a plurality of heat generators to be cooled, wherein the heat exchanger is arranged downstream of the heat generator to be cooled having the greatest heat generation.

5. The electrified drive train according to claim 4, wherein, in addition to the heat exchanger arranged downstream of the heat generator having the greatest heat generation, a further heat exchanger is arranged in the cooling circuit for dividing a cooling capacity, wherein the further heat exchanger is arranged upstream of the heat generator having the greatest heat generation.

6. The electrified drive train according to claim 1, wherein a volume flow of the cooling circuit is divided into partial volume flows which run parallel to one another.

7. The electrified drive train according to claim 6, wherein the volume flow has a partial volume flow for cooling a gearbox and/or a partial volume flow for cooling a clutch.

8. The electrified drive train according to claim 6, wherein the cooling circuit has a hydraulic resistance arranged in the volume flow for adjusting a flow rate of the partial volume flows.

9. The electrified drive train according to claim 3, wherein the drive train has the cooling circuit led through the electric drive machine and a second cooling circuit led through the power electronics, wherein the heat exchanger of the cooling circuit is arranged downstream of the electric drive machine and a heat exchanger of the second cooling circuit is arranged downstream of the power electronics.

10. An electric vehicle comprising: an electrified drive train including a heat generator, which comprises at least one electric drive machine, a pooling circuit, which is led through the electric drive machine and has a heat exchanger for removing heat from the cooling circuit, wherein, with respect to a direction of flow of fluid used in the cooling circuit, the heat exchanger is arranged in the cooling circuit downstream of the heat generator to be cooled.

11. An electrified drive train for a motor vehicle, comprising:
a heat generator having at least one electric drive machine; and
a cooling circuit led through the electric drive machine and having a heat exchanger for removing heat from the cooling circuit, wherein a volume flow of the cooling circuit is divided into partial volume flows which run parallel to one another, wherein the volume flow has a partial volume flow for cooling a gearbox and a partial volume flow for cooling a clutch.

12. The electrified drive train for a motor vehicle according to claim 11, wherein, with respect to a direction of flow of fluid used in the cooling circuit, the heat exchanger is arranged in the cooling circuit downstream of the heat generator to be cooled.
